(19) United States
(12) Patent Application Publication
(10) Pub. No.: US 2010/0096201 A1
(43) Pub. Date: Apr. 22, 2010

(54) DUCT STRUCTURES AND VEHICLES INCLUDING SAME

(76) Inventors: Daisuke Nagao, Long Beach, CA (US); Kenji Tamura, Redondo Beach, CA (US)

Correspondence Address: ULMER & BERNE, LLP;ATTN: DIANE BELL, 600 VINE STREET, SUITE 2800, CINCINNATI, OH, 45202, US

(21) Appl. No.: 12/254,877

(22) Filed: Oct. 21, 2008

(51) Int. Cl. B60K 13/02

(52) U.S. Cl. 180/68.3; 180/68.4

(57) ABSTRACT

A duct structure defines an opening, a first air-intake port, and a second air-intake port. The opening is configured to receive air. The first air-intake port is configured to receive a first portion of air for passage to an engine. The second air-intake port is configured to receive a second portion of air for passage to a radiator. A partition can be provided to separate the air received at the opening into a first portion that is received by the first air-intake port and a second portion that is received by the second air-intake port substantially immediately upon entry of the air into the opening. The duct structure can be provided as part of an air-intake system on a vehicle, such as a motorcycle.

### TECHNICAL FIELD

Duct structures are provided as part of air-intake systems for vehicles, such as motorcycles.

### BACKGROUND

A conventional vehicular air-intake system includes respective provisions which are separate from one another for supplying combustion air to an engine and for supplying ram air for cooling of a radiator.

### SUMMARY

In accordance with one embodiment, a motorcycle comprises a frame, a front wheel, a rear wheel, an engine, a radiator, and an air-intake system. The frame extends along a longitudinal axis from a forward end to a rearward end. The front wheel is rotatably supported with respect to the frame adjacent to the forward end. The rear wheel is rotatably supported with respect to the frame adjacent to the rearward end. The engine is supported with respect to the frame. The radiator is supported with respect to the frame. The air-intake system comprises a duct structure, a first conduit, and a second conduit. The duct structure comprises an opening adapted to receive air and disposed adjacent to the forward end of the frame. The duct structure further comprises a first air-intake port and a second air-intake port which are each adjacent to the opening. The first conduit is coupled with the first air-intake port and is configured to facilitate passage to the engine of air from the first air-intake port. The second conduit is coupled with the second air-intake port and is configured to facilitate passage to the radiator of air from the second air-intake port.

In accordance with another embodiment, a vehicle comprises a frame, an engine, a radiator, a duct structure, a first conduit, and a second conduit. The frame extends along a longitudinal axis from a forward end to a rearward end. The engine is supported with respect to the frame. The radiator is supported with respect to the frame. The duct structure is supported with respect to the frame adjacent to the forward end. The duct structure defines a first air-intake port and a second air-intake port. The duct structure is configured to receive and separate air for respective passage to the first air-intake port and the second air-intake port substantially immediately upon entry of the air into the duct structure. The first conduit is coupled with the first air-intake port of the duct structure and is configured to facilitate passage to the engine of air received by the first air-intake port. The second conduit is coupled with the second air-intake port of the duct structure and is configured to facilitate passage to the radiator of air received by the second air-intake port.

In accordance with yet another embodiment, a duct structure is configured for receiving air for passage to an engine and a radiator of a vehicle. The duct structure comprises a body defining an opening, a first air-intake port, a second air-intake port, and a partition. The opening is configured to receive air. The first air-intake port has a first entrance and a first exit. The first entrance is adjacent to the opening and is configured for receiving a first portion of the air received at the opening. The first exit is configured for connection for facilitating provision of the first portion of the air to an engine. The second air-intake port has a second entrance and a second exit. The second entrance is adjacent to the opening and is configured for receiving a second portion of the air received at the opening. The second exit is configured for connection for facilitating provision of the second portion of the air to a radiator. The partition is disposed adjacent to the first air-intake port and the second air-intake port. The partition separates the first air-intake port from the second air-intake port and is configured to separate the air received at the opening into the first portion and the second portion substantially immediately upon entry of the air into the opening in the duct structure.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a side elevational view depicting a motorcycle having an air-intake system in accordance with one embodiment;

FIG. 2 is a front elevational view depicting a portion of the motorcycle of FIG. 1: and

FIG. 3 is a schematic illustration depicting the flow of air in the air-intake system of FIG. 1.

### DETAILED DESCRIPTION

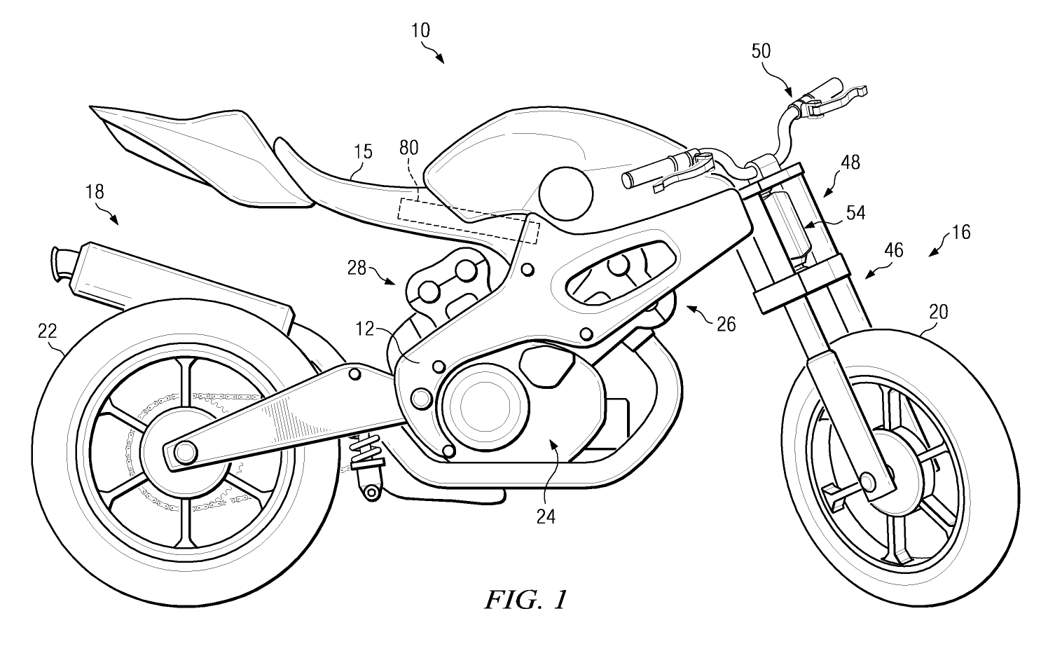

Embodiments are hereinafter described in detail in connection with the views of FIGS. 1-3, wherein like numbers indicate the same or corresponding elements throughout the views. An air-intake system in accordance with one embodiment can be configured to channel air to an engine and a radiator of a vehicle. The air-intake system, the engine, and the radiator can be provided upon a vehicle such as, for example, a saddle-type vehicle, an automobile, a truck, a van, a watercraft, or an aircraft. A saddle-type vehicle can include, for example, a motorcycle, a scooter, an all terrain vehicle, a personal watercraft, and a snowmobile. The engine can comprise any of a variety of types such as, for example, a V-type engine having two cylinder housings (i.e., a V-twin engine). The engine can be configured to consume any of a variety of fuels such as, for example, gasoline, diesel fuel, propane, alcohol, jet fuel, hydrogen, or kerosene.

In accordance with one embodiment, as shown in FIG. 1, a motorcycle 10 can comprise a frame 12, a front wheel 20, a rear wheel 22, and an engine 24. The frame 12 can generally extend along a longitudinal axis from a forward end 16 of the motorcycle 10 to a rearward end 18 of the motorcycle 10. The engine 24 is shown to comprise a V-twin engine having first and second cylinder housings 26 and 28. The engine 24 can be supported with respect to the frame 12 and can be directly or indirectly attached to the frame 12. The motorcycle 10 is also shown to comprise a front fork 46 attached to the frame 12 adjacent to the forward end 16 of the motorcycle 10. The front wheel 20 can be rotatably attached to the front fork 46 such that the front wheel 20 is supported with respect to the frame 12 adjacent to the forward end 16 of the motorcycle 10. A handlebar 50 can be attached to the front fork 46 to facilitate steering of the front fork 46 and the front wheel 20 and, thus, the motorcycle 10. The rear wheel 22 is shown to be supported with respect to the frame 12 adjacent to the rearward end 18 of the motorcycle 10.

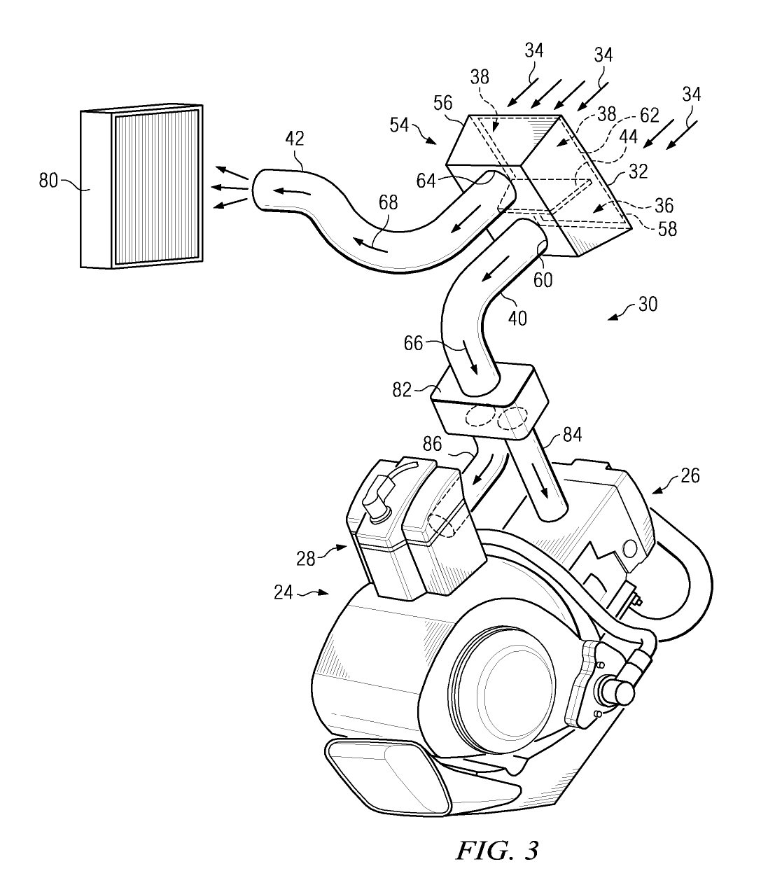

In accordance with one embodiment, an engine might require receipt of air in order to facilitate its combustion of fuel, and resultant powering of an associated vehicle. A radiator might also require receipt of air for cooling purposes. An air-intake system in accordance with one embodiment can be configured to provide this air to both the engine and the radiator. For example, as shown in FIGS. 1-3, an air-intake system 30 can be configured to provide air to an engine 24 and a radiator 80 present upon the motorcycle 10. The radiator 80 can be disposed in any of a variety of locations upon the motorcycle 10. For example, the radiator 80 (shown generally in dashed lines in FIG. 1, and schematically in FIG. 3) can be supported with respect to the frame 12 of the motorcycle 10 at a location above the engine 24 and beneath a seat 15 of the motorcycle 10 and can, for example, be attached directly or indirectly to the seat 15.

In accordance with one embodiment, the air-intake system 30 can comprise a duct structure 54, a first conduit 40, and a second conduit 42. The duct structure 54 can comprise a body 56 and can be configured for receiving air (e.g., 34 in FIG. 3). The body 56 can define an opening 32, a first air-intake port 36, a second air-intake port 38, and a partition 44. The duct structure 54 may be configured such that the first air-intake port 36, the second air-intake port 38, and the partition 44 are integrally formed by the body 56. In accordance with one embodiment, the first air-intake port 36, the second air-intake port 38, and the partition 44 are integrally formed (e.g., by molding) of plastic. In another embodiment, the first air-intake port 36, the second air-intake port 38, and the partition 44 can be integrally formed from some other material such as metal, rubber, fiberglass, or carbon-fiber. In still another embodiment, the first air-intake port, the second air-intake port, and the partition might not be integrally formed, but might rather be formed from separate components which are attached together with adhesives, fasteners, and/or otherwise.

In one embodiment, the partition 44 can be disposed adjacent to the first air-intake port 36 and the second air-intake port 38. The opening 32 can be adapted to receive air (e.g., 34 in FIG. 3) and the partition 44 can be adapted to separate the air (e.g., 34) between the first air-intake port 36 and the second air-intake port 38. In one embodiment, the partition 44 can be adjacent to the opening 32 such that air received by the opening 32 is separated by the partition 44 between the first and second air-intake ports 36 and 38 substantially immediately upon entry of the air into the opening 32 of the duct structure 54.

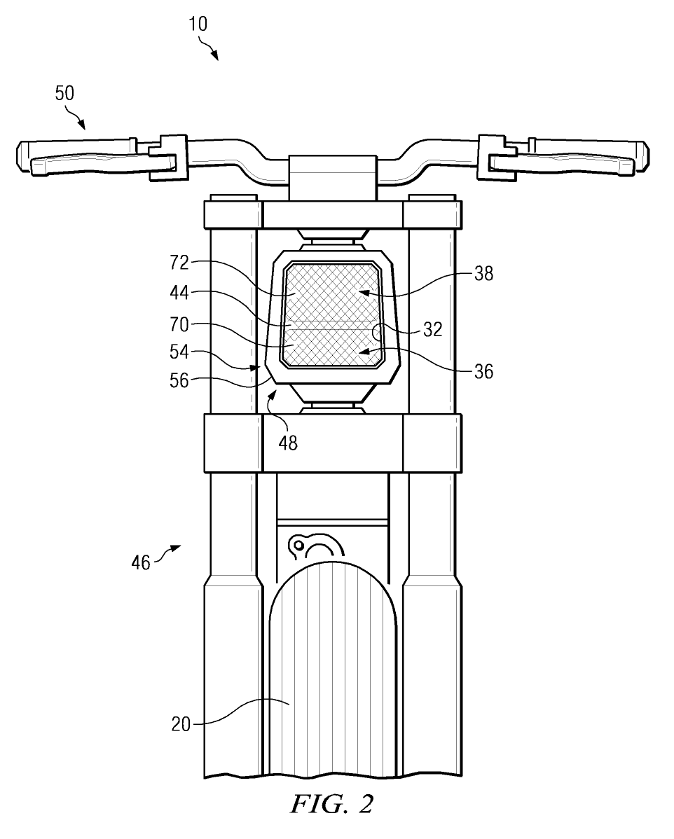

As shown in FIGS. 1-2, the duct structure 54 can be provided upon the motorcycle 10 such that the opening 32 is disposed adjacent to the forward end 16 of the motorcycle 10. For example, in accordance with one embodiment, as shown in FIGS. 1-2, the duct structure 54 may be configured for attachment to the motorcycle 10 such that the opening 32 can be forward-facing so that it can directly receive air (e.g., 34) moving in a direction parallel to the longitudinal axis of the motorcycle 10 (i.e., ram or thrust air). More particularly, according to this embodiment, the front fork 46 can define a passageway 48. The opening 32 can be disposed adjacent to the passageway 48 such that the opening 32 receives at least some of the air (e.g., 34) which travels through the passageway 48. In accordance with one embodiment, as shown in FIGS. 1-2, the passageway 48 and the opening 32 may be disposed at a vertical position located substantially between respective vertical positions of the front wheel 20 and the handlebar 50. It will be appreciated that positioning the opening 32 as shown in FIGS. 1-2 can allow for optimal air flow into the opening 32, can minimize entry of road debris into the opening 32 (due to the height of the opening 32 as compared with the road surface), can avoid any need for conventional side-mounted air ducts which increase the overall width and bulk of a motorcycle, can minimize resistance of air passing through the opening 32 and to the engine 24 and the radiator 80, and can provide certain aesthetic and other advantages.

It will be appreciated that the duct structure 54 of FIGS. 1-3 can facilitate significant air flow into the opening 32 when the motorcycle 10 moves in a forward direction. Also, in this configuration, as the motorcycle 10 travels in a forward direction, the amount of air thrust into the opening 32 of the duct structure 54 increases as the speed of the motorcycle 10 increases. Thus, the air-intake system 30 can provide more air flow to the engine 24 and the radiator 80 as the speed of the motorcycle 10 increases, and as may be required for the engine 24 and the radiator 80 to facilitate and/or accommodate the increased speed of the motorcycle 10. It will therefore be appreciated that an air-intake system (e.g., 30), and particularly its opening (e.g., 32), can be configured to receive a sufficient quantity of air (e.g., 34) to operate an associated engine and effectively cool an associated radiator at any speed within the operating range of the engine and associated vehicle. Other embodiments are contemplated in which the opening of a duct structure is not forward-facing, is not configured to directly receive air moving in a direction parallel to a longitudinal axis of a vehicle, is not disposed adjacent to a forward end of a vehicle, is not disposed adjacent to a passageway defined by a front fork, and/or is not disposed at a vertical position located substantially between respective vertical positions of a front wheel and a handlebar of a vehicle.

The opening 32 in the duct structure 54 can be provided to have any of a variety of shapes and dimensions provided, however, that the opening 32 is configured to receive a sufficient quantity of air (e.g., 34) to operate the engine 24 and cool the radiator 80. The opening 32 may be polygonal in shape (e.g., square, rectangular, triangular, rhombus) such as shown in FIG. 2. However, an opening in a duct structure can alternatively be shaped as a circle or an ellipse, for example.

The duct structure 54 can be configured such that the air 34 received by the opening 32 is conveyed to the engine 24 and the radiator 80. The engine 24 and the radiator 80 can accordingly be configured to receive respective portions of the air (e.g., 34) received by the opening 32. More particularly, the first air-intake port 36 can be configured to receive a first portion (e.g., 66) of the air (e.g., 34) received by the opening 32, while the second air-intake port 38 can be configured to receive a second portion (e.g., 68) of the air (e.g., 34) received by the opening 32. The first air-intake port 36 can have a first entrance 58 and a first exit 60. The first entrance 58 can be provided adjacent to the opening 32 and can be configured for receiving the first portion (e.g., 66) of the air (e.g., 34) received at the opening 32.

The first exit 60 can be configured for connection for facilitating provision of the first portion (e.g., 66) of the air (e.g., 34) to the engine 24. For example, as shown in FIG. 3, the first exit 60 can be connected to the first conduit 40 which connects to an air box 82 which divides the first portion 66 of the air 34 for passage via respective conduits 84, 86 to respective first and second cylinder housings 26, 28 of the engine 24. While the engine 24 is shown to include only two cylinder housings (i.e., 26, 28) it will be appreciated that any number of conduits can be provided from the air box 82 for connection to any number of respective engine cylinder housings. In other embodiments in which an engine only comprises a single cylinder housing, it will be appreciated that the first conduit 40 might lead directly from the first exit 60 to the engine cylinder housing. It will also be appreciated that an alternative duct structure might comprise respective exits for connection with respective conduits leading directly from the duct structure to respective cylinder housings of an engine.

The second air-intake port 38 can have a second entrance 62 and a second exit 64. The second entrance 62 can be adjacent to the opening 32 and can be configured for receiving the second portion (e.g., 68) of the air (e.g., 34) received at the opening 32. The second exit 64 can be configured for connection for facilitating provision of the second portion (e.g., 68) of the air (e.g., 34) to the radiator 80. In accordance with one embodiment, as shown in FIG. 2, the first and second entrances 58 and 62 can each be at least partially defined by cooperation of the opening 32 and the partition 44. In accordance with one embodiment, each of the first and second air-intake ports 36 and 38 can be provided adjacent to the opening 32 of the duct structure 54, as shown in FIGS. 2-3.

As shown in FIG. 3, the duct structure 54 can be attached to the first and second conduits 40 and 42 of the air-intake system 30. The first conduit 40 can be coupled with the first air-intake port 36 of the duct structure 54. The first conduit 40 can be configured to facilitate passage of air from the first air-intake port 36 to the engine 24. More particularly, the first conduit 40 can be configured to receive the first portion (e.g., 66) of the air (e.g., 34) received by the first air-intake port 36 from the opening 32, and to then convey this air to the engine 24. In one embodiment, substantially no air other than the portion of air (e.g., 66) received by the first air-intake port 36 is received into the first conduit 40 and/or is conveyed to the engine 24 by the air-intake system 30.

The second conduit 42 can be coupled with the second air-intake port 38 of the duct structure 54. The second conduit 42 can be configured to facilitate passage of air from the second air-intake port 38 to the radiator 80. More particularly, the second conduit 42 can be configured to receive the second portion (e.g., 68) of the air (e.g., 34) received by the second air-intake port 38 from the opening 32, and to then convey this air to the radiator 80. In one embodiment, substantially no air other than the portion of air (e.g., 68) received by the second air-intake port 38 is received into the second conduit 42 and is conveyed to the radiator 80 by the air-intake system 30. In this configuration, it will be appreciated that the separated air (e.g., portion 66) passing from the first air-intake port 36 to the engine 24 remains separate within the air-intake system 30 from the separated air (e.g., portion 68) passing from the second air-intake port 38 to the radiator 80. As such, in one embodiment, as shown in the example of FIGS. 1-3, no substantial or significant portion of the air-intake system 30 may allow mixing of air respectively traveling to the engine 24 and the radiator 80. By combining respective air-intakes into a single duct structure for feeding both an engine and radiator, it will be appreciated that weight, bulk, and/or cost advantages can be achieved as compared to certain conventional configurations. Also, by separately routing air to an engine and radiator, it will be appreciated that the duct structure can facilitate reduced air resistance, and can accordingly achieve improved performance of both the engine and the radiator.

In accordance with one embodiment, each of the first and second conduits 40 and 42 can comprise ducts, pipes, or tubes, for example. The first and second conduits 40 and 42 can either be flexible or inflexible, and can be formed from rubber, plastic, metal, fiberglass, carbon fiber, or some other material. While each of the first and second conduits 40 and 42 are shown in FIG. 3 as being attached to the duct structure 54, it will be appreciated that one or both of the first and second conduits might alternatively be provided integrally with a duct structure in accordance with an alternative embodiment. Accordingly, the first and second conduits 40 and 42 can be formed from any of a variety of materials, and in any of a variety of configurations, provided that, however, the first and second conduits 40 and 42 can each respectively facilitate the passage of air from the duct structure 54 to the engine 24 and the radiator 80. It will be appreciated that, in one embodiment, a conduit can facilitate passage of air from a duct structure to an engine or radiator by conducting the air the entire distance between the duct structure and the engine or radiator (e.g., via a connection of the conduit to both the duct structure and the engine or radiator). However, in an alternative embodiment, a conduit can facilitate passage of air from a duct structure to an engine or radiator by conducting the air only a portion of the entire distance between the duct structure and the engine or radiator, provided that the air is ultimately directed (e.g., through some other structure) to the engine or radiator.

The first and second conduits 40 and 42 may be coupled with the respective first and second air-intake ports 36 and 38 of the duct structure 54 and/or other vehicular components (e.g., the air box 82 and/or the radiator 80) through use of any of a variety of suitable fastening techniques. Such fastening techniques may involve, for example, clamps, clasps, adhesives, and/or other fasteners. Alternatively, such fastening techniques may involve snap-fit or other mechanically interlocking connections, with or without the use of clamps, clasps, adhesives, and/or other fasteners. In still other embodiments, such as when the first and second conduits are integral with the duct structure and/or other vehicular components, no fastening techniques or fasteners may be required to facilitate connections to the first and second conduits.

An air-intake system in accordance with one embodiment can include one or more screens and/or filters which are configured to prevent bugs, road debris, moisture, and/or other contamination from being passed along to an associated engine and/or radiator. For example, a screen or filter (not shown) can be provided within the air box 82 for filtering intake air provided to the engine 24 through the duct structure 54. Also, one or more screens (e.g., 70, 72 in FIG. 2) can be provided within the air-intake ports (e.g., 36, 38) of the duct structure 54. However, it will be appreciated that screens and/or filters can otherwise be associated with or supported by a duct structure and/or other portion of an air-intake system in any of a variety of alternative configurations in accordance with various embodiments.

While a duct structure in accordance with one embodiment might only comprise two air-intake ports (e.g., 36 and 38), it will be appreciated that a duct structure in accordance with certain alternative embodiments may include more than two air-intake ports. For example, in one alternative embodiment, in addition to first and second air-intake ports, a duct structure might include a third air-intake port. The third air-intake port can be configured to receive a third portion (e.g., other than portions 66 and 68) of the air (e.g., 34) received by an opening (e.g., 32) in the duct structure, and to then separately direct this third portion of air (e.g., apart from portions 66 and 68) to a radiator, engine cylinder housing, and/or some other component such as an engine control unit or other electrical or mechanical device. For example, the third air-intake port can be configured to provide air to a radiator, while the first and second air-intake ports can be configured to respectively provide air to first and second cylinder housings of a V-twin engine. While one or more pipes, ducts, or other conduits may be connected to the third air-intake port, it will be appreciated that no such conduit may be provided in certain embodiments. When a duct structure has more than two air-intake ports, it will be appreciated that the duct structure can include one or more additional partitions (e.g., similar to, and in addition to, partition 44) which are disposed adjacent to the opening (e.g., similar to 32) of the duct structure, and which cooperate with the opening and/or other partitions of the duct structure to separate air substantially immediately upon entry of the air into an opening of the duct structure.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A motorcycle comprising:
a frame extending along a longitudinal axis from a forward end to a rearward end;
a front wheel rotatably supported with respect to the frame adjacent to the forward end;
a rear wheel rotatably supported with respect to the frame adjacent to the rearward end;
an engine supported with respect to the frame;
a radiator supported with respect to the frame; and
an air-intake system comprising:
a duct structure comprising an opening adapted to receive air, wherein the opening is disposed adjacent to the forward end of the frame, and wherein the duct structure further comprises a first air-intake port and a second air-intake port each being adjacent to the opening;
a first conduit coupled with the first air-intake port and configured to facilitate passage to the engine of air from the first air-intake port; and
a second conduit coupled with the second air-intake port and configured to facilitate passage to the radiator of air from the second air-intake port.

2. The motorcycle of claim 1 wherein the air-intake system comprises a partition adapted to separate air between the first air-intake port and the second air-intake port.

3. The motorcycle of claim 2 wherein the opening is forward-facing and configured to directly receive air moving in a direction parallel to the longitudinal axis.

4. The motorcycle of claim 3 further comprising a front fork attached to the frame adjacent to the forward end, wherein the front fork defines a passageway, the opening is disposed adjacent to the passageway, and the opening is configured to receive air traveling through the passageway.

5. The motorcycle of claim 4 further comprising a handlebar, wherein each of the handlebar and the front wheel are attached to the front fork, and wherein the passageway and the opening are disposed at a vertical position located substantially between respective vertical positions of the front wheel and the handlebar.

6. The motorcycle of claim 1 wherein the engine comprises a V-twin engine.

7. The motorcycle of claim 1 wherein the first air-intake port and the second air-intake port are integrally formed.

8. The motorcycle of claim 7 wherein the first air-intake port and the second air-intake port are integrally formed of plastic.

9. The motorcycle of claim 1 wherein the air-intake system is configured such that air received at the opening is separated between the first air-intake port and the second air-intake port substantially immediately upon entry of the air into the opening, and such that the separated air passing from the first air-intake port to the engine remains separate within the air-intake system from the separated air passing from the second air-intake port to the radiator.

10. A vehicle comprising:
a frame extending along a longitudinal axis from a forward end to a rearward end;
an engine supported with respect to the frame;
a radiator supported with respect to the frame;
a duct structure supported with respect to the frame adjacent to the forward end, wherein the duct structure defines a first air-intake port and a second air-intake port, and wherein the duct structure is configured to receive and separate air for respective passage to the first air-intake port and the second air-intake port substantially immediately upon entry of the air into the duct structure;
a first conduit coupled with the first air-intake port of the duct structure and configured to facilitate passage to the engine of air received by the first air-intake port; and
a second conduit coupled with the second air-intake port of the duct structure and configured to facilitate passage to the radiator of air received by the second air-intake port.

11. The vehicle of claim 10 wherein the duct structure comprises a partition adapted to separate air between the first air-intake port and the second air-intake port.

12. The vehicle of claim 11 wherein the duct structure includes a forward-facing opening configured to directly receive air moving in a direction parallel to the longitudinal axis.

13. The vehicle of claim 10 wherein the engine comprises a V-twin engine.

14. The vehicle of claim 10 comprising a saddle-type vehicle.

15. A duct structure configured for receiving air for passage to an engine and a radiator of a vehicle, the duct structure comprising a body, the body defining:
an opening configured to receive air;
a first air-intake port having a first entrance and a first exit, the first entrance being adjacent to the opening and configured for receiving a first portion of the air received at the opening, the first exit being configured for connection for facilitating provision of the first portion of the air to an engine;
a second air-intake port having a second entrance and a second exit, the second entrance being adjacent to the opening and configured for receiving a second portion of the air received at the opening, the second exit being configured for connection for facilitating provision of the second portion of the air to a radiator; and
a partition disposed adjacent to the first air-intake port and the second air-intake port, wherein the partition separates the first air-intake port from the second air-intake port and is configured to separate the air received at the opening into the first portion and the second portion substantially immediately upon entry of the air into the opening in the duct structure.

16. The duct structure of claim 15 being configured for attachment to a vehicle such that the opening receives air moving in a direction parallel to the longitudinal axis.

17. The duct structure of claim 16 wherein the first air-intake port, the second air-intake port, and the partition are integrally formed.

18. The duct structure of claim 19 wherein the first air-intake port, the second air-intake port, and the partition are integrally formed of plastic.
